(19) United States
(12) Patent Application Publication
(10) Pub. No.: US 2011/0065170 A1
(43) Pub. Date: Mar. 17, 2011

(54) DEVICE FOR THE PRESERVATION OF A HEPATIC GRAFT IN NORMOTHERMIA

(75) Inventors: Constantino Fondevila Campo, Barcelona (ES); Angel Ruiz Arranz, Barcelona (ES); Juan Carlos Garcia-Valdecasas Salgado, Barcelona (ES)

(73) Assignee: FUNDACIO PRIVADA CLINIC PER A LA RECERCA BIOMEDICA, Barcelona (ES)

(21) Appl. No.: 12/992,437

(22) PCT Filed: May 14, 2009
(86) PCT No.: PCT/EP2009/055816

§ 371 Date: Nov. 17, 2010

(30) Foreign Application Priority Data
May 14, 2008 (ES) P200801402

(51) Int. Cl. A01N 1/02

(52) U.S. Cl. 435/284.1

(57) ABSTRACT

The invention relates to a device for the preservation of a hepatic graft in normothermia comprising a receptacle in which said hepatic graft is housed in a preservation solution, an arterial perfusion circuit, a portal perfusion circuit, at least one flow sensor of a perfusion circuit, and at least one pressure sensor of a perfusion circuit. For the purpose of increasing the preservation of the hepatic graft, the preservation device additionally comprises an arterial oxygenator connected to the arterial perfusion circuit, a portal oxygenator connected to the portal perfusion circuit, at least one arterial perfusion pump, at least one portal perfusion pump, a temperature exchange module configured to maintain the temperature inside the receptacle in normothermia, and a pressure and flow control device.

### FIELD OF THE INVENTION

The present invention pertains to the field of organ preservation devices, either for a subsequent transplant posterior or for taking samples. More specifically, it relates to a device for the preservation of a hepatic graft in normothermia, i.e., at a temperature similar to that of the human body.

### BACKGROUND OF THE INVENTION

Liver transplant is the only valid therapy in patients with liver disease in a terminal stage. However, it has a very low rate of application due to the scarcity of transplant organs. Between 10 and 30% of patients in the European Union and in the United States die on a waiting list to receive a suitable transplant liver.

The selection of a suitable donor is crucial for the success of the liver transplant. The purpose of the evaluation of the liver donor is to identify those organs having high probabilities of suitably functioning and rejecting those which will foreseeably fail.

The time of hypothermic preservation or cold ischemia (0-4°), which is performed using preservation solutions such as the Wisconsin solution to reduce metabolic activity of the organs, is one of the most important parameters determining the subsequent viability of the graft. Thus is it well known how periods exceeding 10 hours of cold ischemia are associated with a high incidence of functional failure of the hepatic graft and how the grafts referred to as sub-optimal do not tolerate cold ischemia as well. The primary dysfunction of the hepatic graft, which can be presented by up to 23% of the transplants, is one of the main causes of death after the transplant.

During ischemic preservation the oxygen, cofactors and nutrient supply to the liver is interrupted. Anoxia conditions an anaerobic metabolism using lactic glycolysis as an energy source, which determines a reduction of intracellular pH and an accumulation of lactic acid. This acidosis causes a cascade of reactions at the cell level which are responsible for the loss of the transcellular electrolyte gradient with the subsequent cell edema, free calcium influx, and the activation of intracellular proteolytic enzymes. On the other hand, the absence of oxygen at the mitochondrial level determines the depletion of cell energy deposits of ATP, the metabolites of which are reduced to hypoxanthine. Hypoxanthine gives rise to the production of large amounts of oxygen free radicals during reperfusion, one of the main factors which are responsible for tissue injury.

Due to injury by ischemia/reperfusion (I/R) inherent to the process of hepatic preservation, and especially in organs from sub-optimal donors, it is necessary to search for new alternatives for the storage of organs which allow the use thereof. For the purpose of minimizing injuries due to tissue ischemia it is necessary to search for alternatives to cold preservation since it is not an effective method for recovering most livers from sub-optimal donors such as those from non-heart-beating donors or grafts with steatosis.

However, performing an ex vivo normothermic perfusion of livers, which allows keeping a liver functioning in physiological conditions outside the organism, entails certain technical difficulties which are the reason its use has not been established as common practice in the clinical environment.

Experimental models have shown how the hepatic preservation with oxygenated perfusion machines significantly improves the viability of parenchyma and mitigates vascular immunogenicity of pre-injured livers. Furthermore, the use of normothermic perfusion machines allows evaluating the efficacy of cytoprotective substances as it is possible to evaluate the response of the organ during this period and thus determine if they can be useful after the transplant in the recipient of the organ.

Porcine livers have been maintained for 24 hours using normothermic perfusion machines, demonstrating the better viability of these organs compared with cold-preserved livers. Parameters relating to glucose metabolism, galactose clearance and bile or factor V production are clearly better with perfusion with normothermic blood.

The patented devices for perfusing the liver in normothermia include, for example, Chinese patent CN 1543785. In this patent, the organ is maintained in normothermia by means of a hot water bath. In other words, the chamber in which the hepatic graft is located is introduced in another larger chamber in which there is hot water and the organ and the perfusion solution are thus maintained in normothermia.

United States patent applications US 2006/0154357 and US 2006/0154358 describe a portable machine for maintaining an organ ex vivo in physiological conditions but specifically designed for maintaining a heart in a beating state. The special anatomical and physiological characteristics of the heart make this system have specifications making this device unsuitable for its use as a liver perfusion system.

United States patent application US 2007/0009881 describes a machine which can be used to perfuse different organs and tissues. The machine described in said patent has a cover surrounding the organ to completely isolate it from the perfusion fluid. On the other hand, the system incorporates a dialyzer as part of the recirculation system.

Application PCT WO 2005/009125 relates to a machine for preservation in hypothermia. The design of such machine is different and includes a reservoir for being filled with ice and thus maintaining the organ in hypothermic conditions. Although it is mentioned in the text that if the latter is not carried out, an organ can be maintained at 37° C., there is no specific system which allows analyzing the technical viability of this alternative.

### DESCRIPTION OF THE INVENTION

The invention relates to a device for the preservation of a liver or hepatic graft in normothermia conditions. Normothermia will be considered the storage of the hepatic graft at a temperature considered normal for the human body, i.e., between 35.5° C. and 37.5° C.

The device of the present invention shall consist of a receptacle in which the hepatic graft will be housed. The hepatic graft in the receptacle will be surrounded by a preservation solution, which will have the characteristics necessary for maintaining the hepatic graft in optimal conditions. Typically, said preservation solution could be whole blood or isolated erythrocytes which will be diluted in another type of solution. The receptacle can be designed such that its closure is sliding and leak-tight, such that once the receptacle is closed, the only ways in and out are the conduits or cannulas which are made.

In this sense, the device comprises an arterial perfusion circuit, which allows the perfusion of a perfusion solution into hepatic graft. The perfusion will be performed with a certain pressure and with a certain flow of the perfusion solution. The perfusion circuit can comprise a cannula which enters the receptacle from the outside, being connected to the hepatic artery. It will additionally comprise an independent portal perfusion circuit. As in the previous case, the portal perfusion circuit will perfuse a perfusion solution through the portal vein with a certain pressure and with a certain flow. A different cannula will thus be introduced in the receptacle and will be connected to the portal vein to perform the perfusion.

According to the invention, said device for the preservation of a hepatic graft additionally comprises at least one flow sensor to measure the value of the flow of the perfusion solution in at least one perfusion circuit. Both the arterial and the portal perfusion circuits can include said at least one flow sensor. For the purpose of determining or measuring the pressure in the arterial and portal perfusion circuits, said at least one perfusion circuit can include at least one pressure sensor. The pressure and flow of the perfusion circuits that may exist in the device can thus be measured individually. This independent measurement of the pressure and the flow is vital, given that the arterial perfusion circuit and the portal perfusion circuit have radically different flow and pressure characteristics, as will be described below. One will have a high pressure and a pulsatile flow and the other one will have a low pressure and continuous flow.

The preservation device comprises at least one oxygenator connected with at least one perfusion circuit. The oxygenator can be a membrane oxygenator and can be connected to an oxygen source. The oxygen can thus be diffused through the membrane and oxygenate the perfusion solution. There can be a single oxygenator common for the portal and arterial perfusion circuits, or two oxygenators, one for the arterial perfusion circuit and the other one for the portal perfusion circuit. The presence of these two oxygenators assures the oxygen supply necessary for the correct preservation of the hepatic graft. Additionally, compared to normal perfusion conditions, the hepatic graft preserved in the device of the invention will have an additional oxygen supply through the portal perfusion circuit in which, in normal conditions, oxygen does not reach the hepatic graft.

Each perfusion circuit will have at least one perfusion pump, the at least one pump of the arterial perfusion circuit being independent of the at least one portal perfusion pump. The features of both pumps will be different due to the different pressure requirements of the arterial and portal circuits. Therefore, the at least one arterial perfusion pump can be a high pressure and pressure and pulsatile flow pump, whereas the at least one portal perfusion pump can be a low pressure and continuous flow.

The preservation device for preserving the hepatic graft additionally comprises a temperature exchange module, such that said module maintains the temperature inside the receptacle in normothermia, i.e., between 35.5° C. and 37.5° C. mentioned above. Therefore, the preservation temperature of the hepatic graft can be controlled with the temperature exchange module, thus assuring that despite the conditions outside the preservation device, the graft will be at a temperature considered normal.

For the purpose of controlling and monitoring the operation of the preservation device, the latter includes a pressure and temperature control device. Based on the readings of the pressure sensors in the arterial and portal perfusion circuits, the control device will select the value of the flow in said perfusion circuits.

The preservation device for preserving the hepatic graft of the invention thus achieves longer graft storage periods since the arterial perfusion circuit is independent of the portal perfusion circuit, each of them therefore adapting to the actual requirements of each of the circuits.

In this sense, each of the perfusion circuits has its own pump adapting the pressure and the flow within the actual perfusion circuit. In the same manner, both the arterial and the portal perfusion circuits have one oxygenator, thus supplying to the hepatic graft the oxygen so that the hepatic graft has a sufficient supply of this substance in order to be preserved for the longest time period possible outside the body. The incorporation of an oxygenator in the portal perfusion circuit, in which a priori there should be no oxygen supply, improves the preservation due to the additional oxygen supply through this circuit, through which, in the situation in which the hepatic graft is in the body, it did not receive oxygen previously.

The proposed device is a hepatic preservation machine for performing normothermic perfusion with an oxygenated solution, which can contain erythrocytes as the oxygen-carrying element, in substitution of cold preservation. With normothermic perfusion, it is possible to maintain physiological aerobic metabolism, preventing tissue acidosis and providing substrates to the hepatic graft which are necessary for cell homeostasis. This allows re-establishing the energy load and the normalization of intracellular ATP levels as well as the elimination of the possible harmful metabolites generated in the organ during the donation process. All this improves the quality of the graft.

The possibility of the hepatic graft being placed in the receptacle in a position opposite to the normal anatomical position is additionally contemplated. This means that the inner face of the liver would be placed facing up and the upper face would be facing down, such that the vascular structures of the hepatic hilum would be located in the upper area, thus facilitating cannulating the hepatic graft, and therefore its preservation. In this situation, a porous fabric can hold the hepatic graft inside the receptacle. The porous fabric can be located one about two or three centimeters approximately from the bottom, lower part or end of the receptacle, such that the entire hepatic graft is immersed in or surrounded by the preservation solution.

The perfusion solution used can be the same solution as the preservation solution. This would be possible, for example, if the perfusion solution, which ends up being expelled from the hepatic graft through the hepatic vein, is not channeled and is collected in the receptacle for preserving the hepatic graft. This solution could be drained through the lower part of the receptacle to subsequently be filtered and channeled again through the arterial and portal perfusion circuits, the perfusion solution thus being the same as the preservation solution.

The bile production caused by the hepatic graft while it is being preserved can be isolated and channeled by means of a cannula which will isolate it from the perfusion and storage solutions and will channel it to a reservoir. Said bile production can be controlled by the control device, given that bile production is an indicator of the state of preservation of the hepatic graft.

A measurement which must be followed and controlled throughout the entire preservation process is the temperature of the hepatic graft. For the purpose of being able to perform this control, the preservation device comprises a temperature sensor which will measure the temperature of the hepatic graft while it is contained inside the receptacle.

### DESCRIPTION OF THE DRAWINGS

To complement the description being made and for the purpose of aiding to better understand the features of the invention, a set of drawings is attached as an integral part of said description, in which with the following is depicted with an illustrative and non-limiting character:

FIG. 1 shows a schematic view of the device for the preservation of a hepatic graft object of the present invention.

### PREFERRED EMBODIMENT OF THE INVENTION

A preferred embodiment of the device for the preservation of a hepatic graft (1) object of this invention is described below in relation to the drawings.

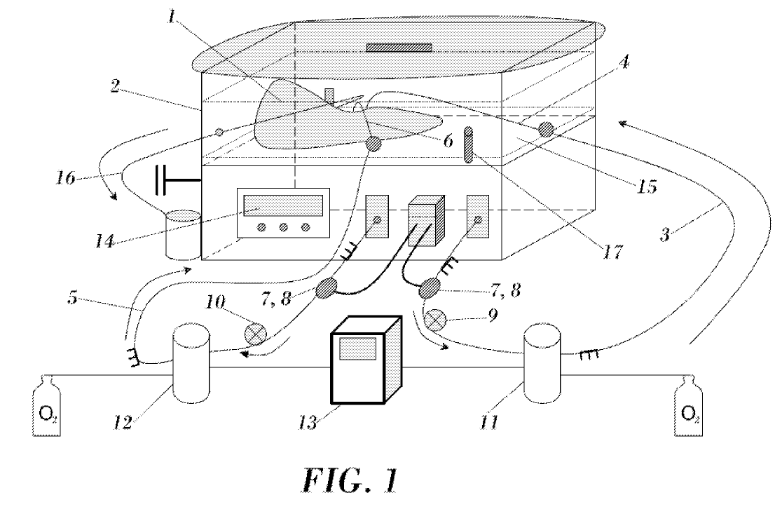

FIG. 1 shows the receptacle (2), or chamber, in which the hepatic graft (1) is contained for its preservation. Said receptacle (2) can be opened to introduce the hepatic graft (1) and perform the cannulation. Once the hepatic graft (1) has been introduced and the cannulas coupled, the receptacle (2) will be closed in a leak-tight manner.

The hepatic graft (1) inside the receptacle (2) will be placed on a porous fabric (15), the hepatic graft (1) being immersed in a preservation solution. Said preservation solution can be blood in a preferred embodiment, or a dilution of erythrocytes in serum.

The position of the hepatic graft (1) in the porous fabric (15) will be a position opposite to the normal position of the hepatic graft (1) in an erect human body. The part forming the upper end of the hepatic graft (1) in an erect body will rest on the porous fabric (15), therefore being in a lower position. In the opposite sense, the lower end inferior of the hepatic graft in an erect body will be oriented in the upper area on the porous fabric (15). This accommodation of the hepatic graft (1) means that the vascular structures (4, 6) of the hepatic hilum are located at the upper part, facilitating cannulation and therefore preservation.

The invention has two independent perfusion circuits (3, 5) with their corresponding inlet cannulas into the receptacle (2), an arterial perfusion circuit (3) and a portal perfusion circuit (5), the first of them connected to the hepatic artery (4) and the second one to the portal vein (6). Each of these two perfusion circuits (3, 5) comprises a flow sensor (7), a pressure sensor (8), an oxygenator (11, 12) and a perfusion pump (9, 10).

The arterial perfusion circuit (3) will therefore comprise an independent arterial oxygenator (11) and an arterial perfusion pump (9). Said arterial perfusion pump (9) will provide the arterial perfusion circuit (3) with high pressure and a pulsatile flow, similar to that which the hepatic artery (4) would have in the body. In the same manner, the portal perfusion circuit (5) will comprise a portal oxygenator (12) and a portal perfusion pump (10). The portal perfusion pump (10), however, will provide the portal perfusion circuit (5) with low pressure and a continuous flow, similar to that which the portal vein (6) would have if the hepatic graft (1) was in its anatomical position. The arterial oxygenator (11) and the portal oxygenator (12) are two membrane oxygenators connected to an oxygen source, which can be a common source for both.

The arterial (3) and portal (5) perfusion circuits will perfuse a perfusion solution to the hepatic graft (1), sharing a temperature exchange module (13) which will maintain the temperature of the perfusion solution in normothermia, between 35.5° C. and 37.5° C. This perfusion temperature, which is the normal temperature of the body, will allow preserving the hepatic graft (1) in temperature conditions similar to those which the hepatic graft would have in normal conditions, increasing the preservation time, as well as minimizing the cooling and heating operations of those devices requiring refrigeration.

Once the perfusion solution is perfused, it will be drained through its natural conduit, i.e., the hepatic vein. The perfusion solution at this time will be retained inside the receptacle, covering the hepatic graft (1) and carrying out the functions of the preservation solution. The receptacle (2) has an opening through which the preservation solution will be filtered, being able to take samples of the preservation solution both inside the receptacle (2) and outside the receptacle for the purpose of determining the situation of the hepatic graft (1) through the analysis of the characteristics of the preservation solution.

The receptacle (2) has a third cannula for exteriorizing the bile production (16) and the storage of such bile in a reservoir intended for such purpose. The hepatic graft (1) in normal conditions performs bile production (16). The bile production (16) performed during preservation can be useful for checking the state of preservation of the hepatic graft (1). Therefore, the reservoir can have means for obtaining samples of said bile production (16), as well as to measure the amount produced.

The measurements of the flow sensor (7) and pressure sensor (8) of each of the perfusion circuits (3, 5) are communicated with a control device (14) which, with the obtained pressure results, will calculate the necessary flow of preservation solution in each of the perfusion circuits (3, 5). Therefore, the control or determination of the working parameters of each of the perfusion circuits (3, 5) is independent, also improving the preservation of the hepatic graft (1) as a result.

The real temperature of the hepatic graft, which does not have to coincide with the temperature maintained by the temperature exchange module (13), is measured through a temperature sensor (17). Said temperature will be controlled by the control device (14) for the purpose of checking the state of preservation which is being performed with the hepatic graft (1).

The control device (14) can additionally perform the control of the hepatic production (16) discussed above, as well as the situation of the preservation solution. In the same manner, the control device (14) can have a display in which the controlled parameters are shown, also being able to include controls for selecting the operating parameters.

The preservation device will be fed by means of electric power, the source of this electric power being convention, which can include being fed from the network of batteries.

Of all the discussed material, the receptacle (2), the cannulas of the arterial perfusion circuit (3) and portal perfusion circuit (5), the oxygenators (11, 12), the porous fabric (15), the cover or closure of the receptacle (2), the sample collection area and the collection cannula for collecting the bile production (16), will be fungible material.

However, the control device, with the data display, the flow sensor (7) and pressure sensor (8), the oxygen sources feeding the oxygenators (11, 12), the arterial perfusion pump (9) and the portal perfusion pump (10) and power sources or batteries will not be of fungible material.

In view of this description and set of drawings, the person skilled in the art will understand that the invention has been described according to a preferred embodiment thereof, but that multiple variations can be introduced in said preferred realization without departing from the object of the invention as it is claimed.

1. Device for the preservation of an hepatic graft in normothermia comprising:
a receptacle for the hepatic graft, configured to house the hepatic graft and immerse it in or surround it by a preservation solution in a position opposite to the normal anatomical position, with the vascular structures of the hepatic hilum being located in the upper area, and the entire hepatic graft located below,
an arterial perfusion circuit, configured to perfuse a perfusion solution to the hepatic graft with a pressure and a flow into the hepatic graft through the hepatic artery, said arterial perfusion circuit is comprised of at least one arterial perfusion pump, at least one flow sensor, and at least one pressure sensor,
a portal perfusion circuit, configured to perfuse a perfusion solution to the hepatic graft with a pressure and a flow into the hepatic graft through the portal vein, said portal perfusion circuit is comprised of at least one portal perfusion pump at least one flow sensor, and at least one pressure sensor,
at least one oxygenator connected with at least one of the perfusion circuits a temperature exchange module, configured to maintain the temperature inside the receptacle in normothermia,
a pressure and flow control device.

2. (canceled)

3. Device for the preservation of an hepatic graft according to claim 1, wherein a porous fabric holds the hepatic graft.

4. Device for the preservation of an hepatic graft according to claim 1, wherein the perfusion solution used is the same as the preservation solution.

5. Device for the preservation of an hepatic graft according to claim 1, comprising a cannula for isolating the bile production from the perfusion solution and the storage solution and collecting said bile production.

6. Device for the preservation of an hepatic graft according to claim 1, comprising a temperature sensor configured to measure the temperature inside the receptacle.

7. Device for the preservation of an hepatic graft according to claim 1, wherein the preservation solution is whole blood.

8. Device for the preservation of an hepatic graft according to claim 1, wherein the preservation is a solution containing isolated erythrocytes.

9. Device for the preservation of an hepatic graft according to claim 1, wherein the arterial perfusion circuit is configured to perfuse a perfusion solution with a high pressure and a pulsatile flow into the hepatic graft and in that the portal perfusion circuit is configured to perfuse a perfusion solution with a low pressure and a continuous flow.
